(19) United States
(12) Patent Application Publication
(10) Pub. No.: US 2002/0099708 A1
(43) Pub. Date: Jul. 25, 2002

(54) Distributed object system

(75) Inventors: Shinsuke Sawai, Minato-ku (JP); Nobuhisa Hosoi, Minato-ku (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/041,465

(22) Filed: Jan. 10, 2002

(30) Foreign Application Priority Data
Jan. 24, 2001 (JP) 2001-015863

(51) Int. Cl. G06F 7/00; G06F 17/30

(52) U.S. Cl. 707/10

(57) ABSTRACT

A distributed object system includes a plurality of networks having different communication formats and connecting a plurality of client computers and a plurality of server computers. Each client computer has a plurality of network interfaces operating with the different communication formats and a network control unit which specifies one of the networks based on the data for a plurality of server computers and the network interfaces. The client which is generally implemented by a software need not have a function for selecting the networks and thus can be manufactured at a lower cost.

### BACKGROUND OF THE INVENTION

(a) Field of the Invention

The present invention relates to a distributed object system and, more particularly, to a distributed object system which allows a client object to communicate with a plurality of server objects via different networks having different communication formats.

(b) Description of the Related Art

A distributed object technique allows a plurality of client objects on a plurality of networks to communicate with a plurality of sever objects via the networks.

In a conventional distributed object system used for controlling switching systems in a communication network, a lower-order switching system implemented as a client switching system communicates to a higher-order switching system implemented as a server switching system for transmitting/receiving data between the client and the server. In such a system, if a plurality of server switching systems operate on different networks with different communication formats, each client switching system should have a plurality of communication interfaces operating with the different communication formats. This is common to other distributed object systems other than the network switching systems.

In a general distributed object system, it is necessary for a client to store data for a target server, the data including information of the network to which the target sever is connected, the communication path to be selected for connection, the communication format of the server etc. This causes a burden for each client, which is generally implemented as a software, and raises the cost and time for forming the client. Thus, it is desired to allow the each client to be free from storing the data for the servers and controlling the communication interfaces to thereby reduce the cost and time for forming the same.

### SUMMARY OF THE INVENTION

In view of the above, it is an object of the present invention to provide a distributed object system which is capable allowing each client to be free from storing information of the target server and controlling the communication interfaces to reduce the cost and time for forming the same.

The present invention provides a distributed object system having a plurality of computers including a first computer mounting therein a first server object operating with a first communication format, a second computer mounting therein a second server object operating with a second communication format, and a third computer mounting therein at least one client object, and a plurality of networks including a first network connecting the third computer to the first computer and a second network connecting the third computer to the second computer. The third computer includes: first and second network interfaces operating with the first and second networks, respectively; a database for storing information of the first and second server objects, the first and second computers and the first and second network interfaces; and a network control unit for specifying one of the first and second network interfaces and one of the first and second networks based on the information stored in the database to transfer data from the client object to the one of the first and second network interfaces specified.

In accordance with the distributed object system of the present invention, the client object need not have data for the network interfaces and server objects and need not control the operation of the network interfaces, whereby the client object can be formed as a standard client. This reduces the cost and time for forming the client object used in the third computer.

### BRIEF DESCRIPTION OF THE DRAWINGS

FIG. 1 is a block diagram of a distributed object system according to a first embodiment of the present invention.

FIG. 2 is a schematic block diagram of the network control unit shown in FIG. 1.

FIG. 3 is schematic block diagram of the database shown FIG. 1.

FIG. 4 is flowchart of operation for selecting a communication path for a server.

FIG. 5 is a block diagram of a computer having a plurality of clients and the network control unit in the first embodiment.

FIG. 6 is a block diagram of a computer having a plurality of clients and a plurality of network control units in a distributed object system according to a second embodiment of the present invention.

FIG. 7 is a block diagram of the network control unit used in the second embodiment.

### PREFERRED EMBODIMENTS OF THE INVENTION

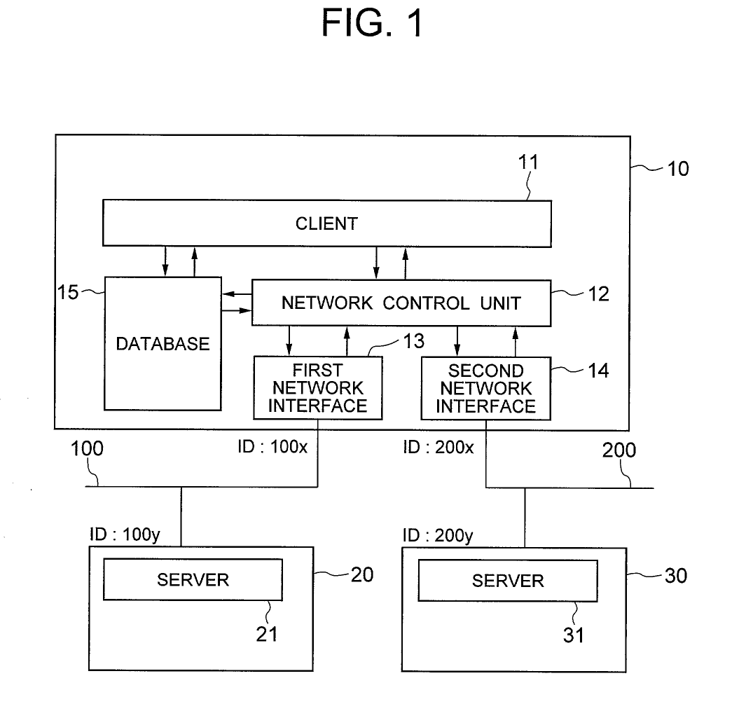

Referring to FIG. 1, a distributed object system according to a first embodiment of the present invention includes a plurality of client computers 10 each mounting therein a client (client object) 11, a first server computer 20 mounting therein a first target server (server object) 21 which is communicated to client computers 10 via a first network 100 by using a first communication format, and a second server computer 30 mounting therein a second target server 31 which is communicated to client computers 10 via a second network 200 by using a second communication format. The distributed object system is preferably implemented as network switching systems used for switching transmission in communication networks.

In FIG. 1, the client computer 10 includes the client 11, a first network interface 13 connected to the first communication network 100, a second network interface 14 connected to the second communication network 200, a network control unit 12 for controlling the first and second network interfaces 13 and 14, and a database 15 for storing data for the client computer 10 and the server computers 20 and 30. It is to be noted that any number of clients or servers may be mounted in the respective computers 10, 20 and 30, and any number of networks may be incorporated in the distributed object system of the present embodiment, although a single client 11 or a single server 21 or 31 is mounted in each computer 10, 20 or 30, and although two communication networks 100 and 200 are exemplified in the present embodiment.

The client 11 in the client computer 10 is communicated to the servers 21 and 31 in the server computers 20 and 30 via respective networks 100 and 200 for transmitting/receiving data between the client 11 and the servers 21 and 22.

The network control unit 12 controls the network interfaces 13 and 14 to transmit/receive data between the client 11 and the network interfaces 13 and 14.

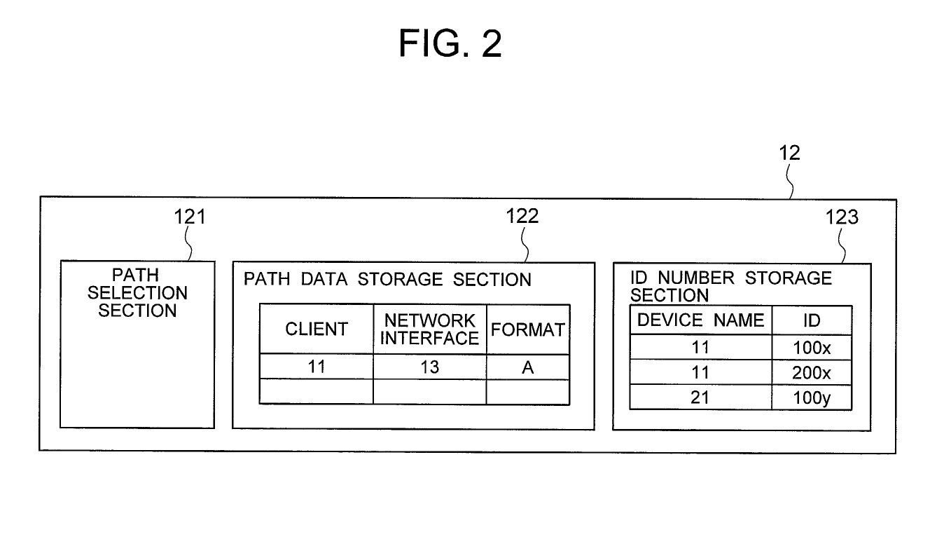

Referring to FIG. 2, the network control unit 12 includes a path selection section 121, a path data storage section 122 and an ID number storage section 123.

The path selection section 121 performs mediation of data transmission between the client 11 and the network interfaces 13 and 14, and selection and control of the network interfaces 13 and 14. The path selection section 121 specifies the network interface 13 or 14 and a communication format corresponding to the target server 21 or 31 before communication between the client 11 and the target server 21 or 31, and transfers the data supplied from the client 11 to the specified network interface 13 or 14.

The path data storage section 122 stores the path data which is retrieved by the path selection section 121 during selection of the path for data transmission. The path data stored in the path data storage section 122 include the name or ID number of the client 11, such as 11, the name or ID number of the network interface, such as 13, and the communication format, such as format A.

The ID number storage section 123 temporarily stores the ID number of the current client, such as 11, and the ID number of each of the current servers, such as 13 and 14, which are compared against each other before selection by the path selection section 121.

The network interfaces 13 and 14 have functions for data transmission/reception to/from the server computers 20 and 30 on the networks 200 and 300. The network interfaces 13 and 14 have ID numbers 100x and 200x, respectively, which are assigned to the computer 10 operating on the networks 100 and 200. The first and second server computers 20 and 30 also have ID numbers 100y and 200y, respectively.

The network interfaces 13 and 14 operate on different communication formats for data transmission based on the different software, different hardware or different protocols, whereby the first network interface 13 operates on the first communication format, or format A, and the second network interface 14 operates on the second communication format, or format B.

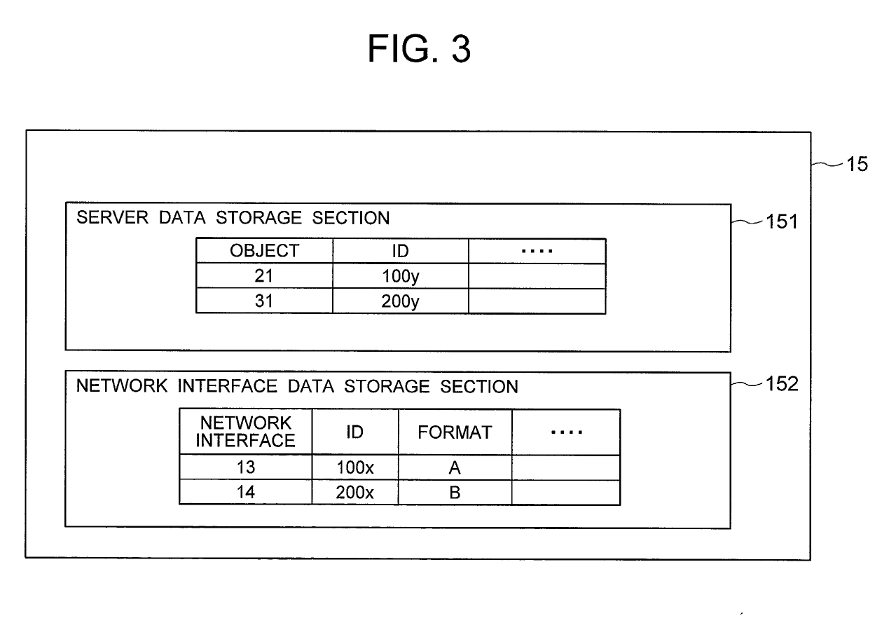

The database 15 stores data to be used in the client computer 10, and includes a server data storage section 151 and a network interface data storage section 152, as shown in FIG. 3.

The server data storage section 151 stores therein information of the servers operating on the networks, such as the object names, 21 and 31, and the ID numbers of the computers, 151, 100y and 200y.

The network interface data storage section 152 stores therein the names of the network interfaces, such as 13 and 14, ID numbers of the network interfaces, such as 100x and 200x, and communication formats of the network interfaces 13 and 14, such as format A and format B.

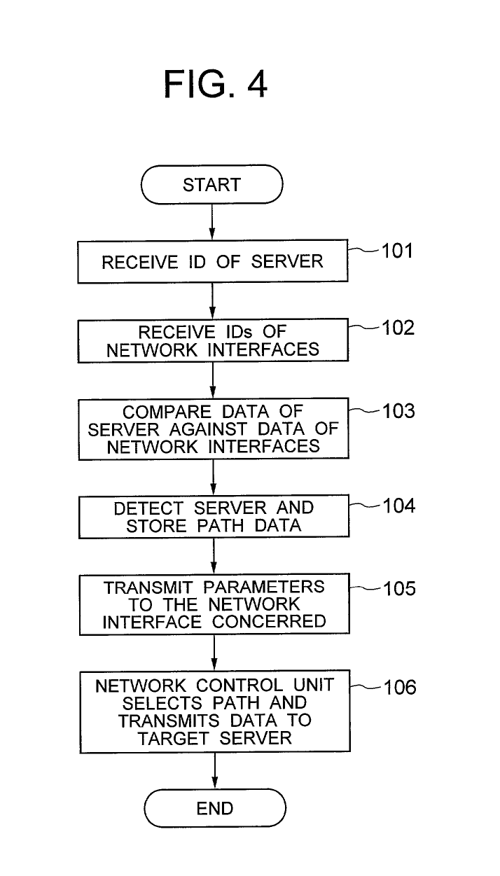

Referring to FIG. 4, for operation of data transmission between the client 11 and the server 21, the client first receives data of the target server 21, such as ID number 100y, from the ID number storage section 151, and transmits the received data to the network control unit 12. Thus, the ID number storage section 123 of the network control unit 12 stores therein the ID number, 100y, of the server computer 20 as the information of the server 21 (step 101).

Subsequently, the network control unit 12 receives the ID numbers, 100x and 200x, of the client computer 10 used on the networks 100 and 200 from the network interface data storage section 152 of the database 15, whereby these ID numbers are stored in the ID number storage section 123 as the data for the client 11 (step 102).

Thereafter, the path selection section 121 of the network control unit 12 compares the data for the server 21 against the ID numbers of the network interfaces 13 and 14 (step 103). More specifically, the path selection section 121 compares the ID number of the server 21 against the ID numbers of the client 11, which are stored in the ID number storage section 123, thereby judging whether or not the server 21 is connected to the same network 100 to which the client 11 is connected. For example, if the network is the IP network, the judgement whether or not both are connected to the same network is conducted by judging whether or not both have the same sub-net.

If it is judged that both the server 21 and the client 11 are connected to the same network, either 100 or 200, the network control unit 12 stores the name of the client 11, the name of the network interface 13 concerned, and the communication format, in the path data storage section (step 104). More specifically, the network control unit stores number 11 for the name of the client, number 13 for the network interface, and the format A for the communication format.

The client 11 then transmits the parameters necessary for communicating with the server 21 to the network control unit 12 (step 105).

The path selection section 121 retrieves data in the path data storage section 122 to select the suitable path, or network interface 13, and the suitable communication format, format A. After the selection, the network interface 13 transmits desired data from the client 11 to the server 21 via the network 100 (step 106).

In the distributed object system of the present embodiment, the present invention is applied to a client computer 10 which mounts therein a client 11 operating on a distributed object technique and is connected to a plurality of networks 100 and 200. The network control unit 12 provided in the computer 10 allows a plurality of network interfaces 13 and 14 having different communication formats to operate for the client 11 in the client computer 10. In this scheme, the client 11 can communicate with a plurality of servers 21 and 32 operating on respective networks 100 and 200, without awareness of the network configurations by the client 10, that is, without storing data of the servers 21 and 31 and the communication interfaces 13 and 14 and controlling the communication interfaces 13 and 14. Thus, the software implementing the client 11 can be created as a standard software.

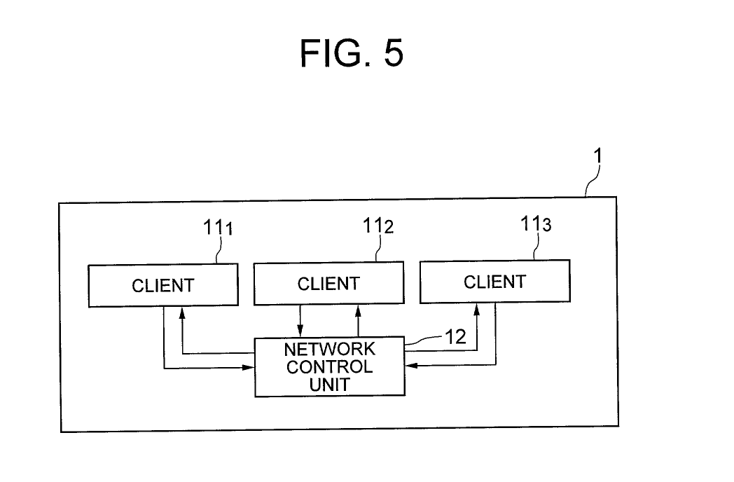

Referring to FIG. 5, a plurality of clients 11₁, 11₂ and 11₃ are mounted in a single client computer 10, with a single network control unit 12 being provided for controlling the networks for the clients 11₁, 11₂ and 11₃. The client computer 10 is connected to the servers (not shown) in the distributed object system having three networks by the function of the single network control unit 12 based on respective communication formats.

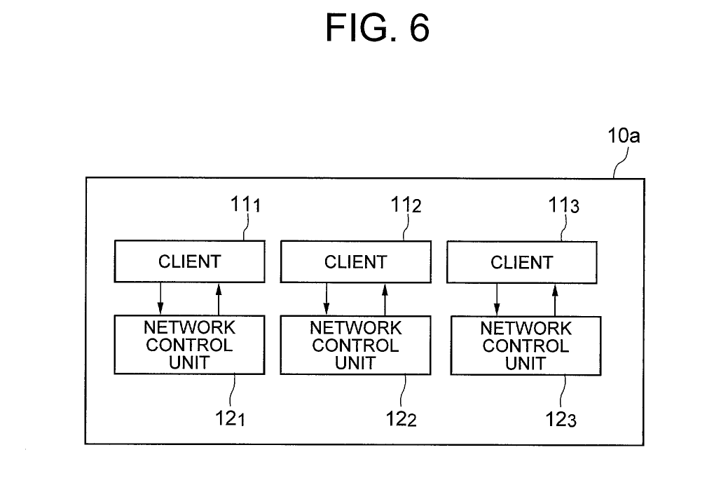

Referring to FIG. 6, a computer 10a for use in a distributed object system according to a second embodiment of the present invention mounts therein a plurality of clients 11₁, 11₂ and 11₃, and a plurality of network control units 12₁, 12₂ and 12₃ each disposed for a corresponding one of the clients 11₁, 11₂ and 11₃.

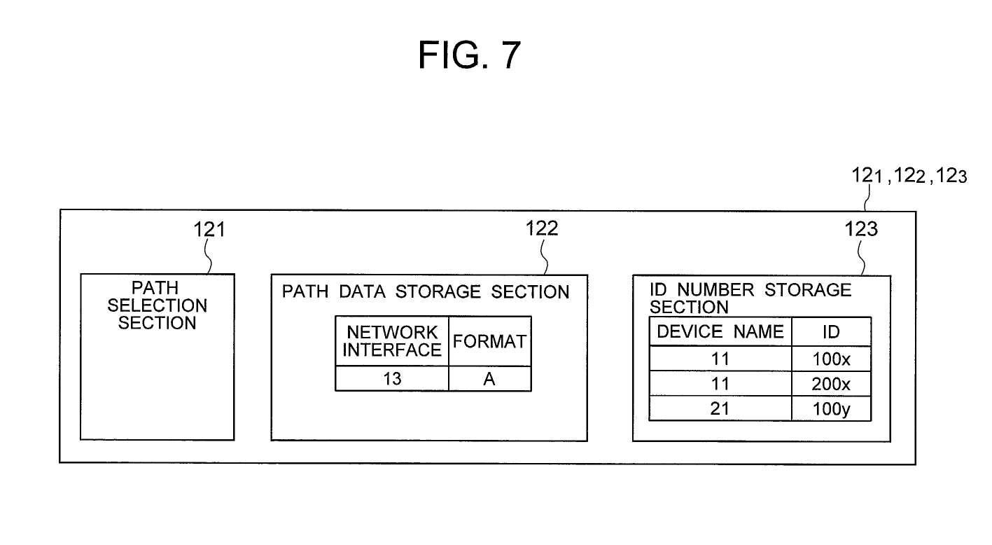

Referring to FIG. 7, each of the network control units 12₁, 12₂ and 12₃ includes a path selection section 121 similar to the path selection section 121 shown in FIG. 2, a path data storage section 122a different from the path data storage section 122 in FIG. 2, and an ID number storage section 123 similar to the ID number storage section 121 shown in FIG. 2. The path data storage section 122a need not store data of the clients 11₁, 11₂ and 11₃ in step 104 of the flowchart shown in FIG. 4, alleviating the burden for the network control units 12₁, 12₂ and 12₃. In addition, the network control units 12₁, 12₂ and 12₃ need not select the data path in step 106.

Since the above embodiments are described only for examples, the present invention is not limited to the above embodiments and various modifications or alterations can be easily made therefrom by those skilled in the art without departing from the scope of the present invention. For example, the present invention is not limited to application in the switching systems used in communication networks.

What is claimed is:

1. A distributed object system comprising a plurality of computers including a first computer mounting therein a first server object operating with a first communication format, a second computer mounting therein a second server object operating with a second communication format, and a third computer mounting therein at least one client object, and a plurality of networks including a first network connecting said third computer to said first computer and a second network connecting said third computer to said second computer, said third computer comprising:
first and second network interfaces communicating to said first and second networks, respectively, based on said first and second communication formats, respectively;
a database for storing information of said first and second server objects, said first and second computers and said first and second network interfaces; and
a network control unit for specifying one of said first and second network interfaces and one of said first and second networks based on said information stored in said database to transfer data from said client object to said specified one of said first and second network interfaces.

2. The distributed object system as defined in claim 1, wherein said database comprises:
a server data storage section for storing names of said first and second server objects and ID data of said first and second computers; and
a network interface data storage section for storing ID data and said communication formats of said first and second network interfaces.

3. The distributed object system as defined in claim 2, wherein said network control unit comprises:
a path selection section for selecting said one of said first and second network interfaces based on data stored in said server data storage section, and selecting said one of said first and second network interfaces and said one of said first and second communication formats based on data stored in said network interface data storage section;
a path data storage section for storing path data indicating relationship between said client object, said selected one of said first and second network interfaces and said selected one of said first and second communication formats; and
an ID number storage section for temporarily storing ID data of said client object and said first and second server objects for allowing selection by said path selection section.

4. The distributed object system as defined in claim 1, wherein said at least one client object includes a plurality of client objects.

5. The distributed object system as defined in claim 1, wherein said computers further include a plurality of fourth computers each including a third server object operating with a third communication format, said networks further include a plurality of third networks each disposed corresponding to each said third server object, and said third computer further includes a plurality of third network interfaces each operating with each said third communication format.

6. A distributed object system comprising a plurality of computers including a first computer mounting therein a first server object operating with a first communication format, a second computer mounting therein a second server object operating with a second communication format, and a third computer mounting therein a plurality of client objects, and a plurality of networks including a first network connecting said third computer to said first computer and a second network connecting said third computer to said second computer, said third computer including:
first and second network interfaces operating with said first and second networks, respectively, based on said first and second communication formats, respectively;
a database for storing information of said first and second server objects, said first and second computers and said first and second network interfaces; and
a plurality of network control units each disposed for activating a corresponding one of said first and second network interfaces and selecting one of said first and second networks based on said information stored in said database to transfer data from said client object to said activated one of said first and second network interfaces.

7. The distributed object system as defined in claim 6, wherein said database comprises:
a server data storage section for storing names of said first and second server objects and ID data of said first and second computers; and
a network interface data storage section for storing ID data and said communication formats of said first and second network interfaces.

8. The distributed object system as defined in claim 6, wherein each of said network control units comprises:
a path selection section for selecting said one of said first and second networks based on data stored in said server data storage section, and selecting said one of said first and second network interfaces and said one of said first and second communication formats based on data stored in said network interface data storage section;
a path data storage section for storing path data indicating relationship between a corresponding one of said client objects, said selected one of said network interfaces and said selected one of said first and second communication formats; and
an ID number storage section for temporarily storing ID data of said corresponding one of said client objects and said server objects for selection by path selection section.
